(19) United States
(12) Patent Application Publication
(10) Pub. No.: US 2005/0083421 A1
(43) Pub. Date: Apr. 21, 2005

(54) Dynamic range enlargement in CMOS image sensors

(76) Inventors: Vladimir Berezin, La Crescenta, CA (US); Richard Tsai, Alhambra, CA (US)

Correspondence Address: DICKSTEIN SHAPIRO MORIN & OSHINSKY LLP, 2101 L Street, NW, Washington, DC, 20037, US

(21) Appl. No.: 10/685,792

(22) Filed: Oct. 16, 2003

(51) Int. Cl. H04N 5/202; H04N 3/14; H04N 5/335

(52) U.S. Cl. 348/308; 348/254

(57) ABSTRACT

A method for operating a pixel circuit is disclosed, wherein a saturation control signal is used to control the photoresponse of four-transistor (4-T), five-transistor (5-T) and shared floating diffusion pixel circuits. The saturation control signal is a variable voltage signal, and is transmitted to a transfer transistor or anti-blooming transistor, wherein the signal opens or partially opens the transistor to allow excess electrons to flow from the photodiode region during an integration period. As a result, the effective dynamic range of the pixel circuit can be extended.

The present invention relates to pixel circuits and more particularly to methods and structures for increasing intrascene dynamic range while reducing fixed pattern noise.

### BACKGROUND OF THE INVENTION

Intrascene dynamic range refers to the range of incident light that can be accommodated by an image sensor in a single frame of pixel data. Examples of scenes that generate high dynamic range incident signals include an indoor room with outdoor window, an outdoor scene with mixed shadows and bright sunshine, night-time scenes combining artificial lighting and shadows and, in an automotive context, an auto entering or about to leave a tunnel or shadowed area on a bright day.

Dynamic range is measured as the ratio of the maximum signal that can be meaningfully imaged by a pixel to its noise level in the absence of light. Typical CMOS active pixel sensors (and charge coupled device (CCD) sensors) have a dynamic range from 60 dB to 75 dB. This corresponds to light intensity ratios of about 1000:1 to about 5000:1. Noise in image sensors, including CMOS active pixel image sensors, is typically between 10 e-rms and 50 e-rms. The maximum signal accommodated is approximately 30,000 electrons to 60,000 electrons. The maximum signal is often determined by the charge-handling capacity of the pixel or readout signal chain. Smaller pixels typically have smaller charge handling capacity.

In order to accommodate high intrascene dynamic range, several different approaches have been proposed in the past. A common denominator of most approaches is performance of signal companding within the pixel by having either a total conversion to a log scale (so-called logarithmic pixel) or a mixed linear and logarithmic response in the pixel.

The current approaches have several major drawbacks. First, the “knee” point in a linear-to-log transition is difficult to control leading to fixed pattern noise in the output image. Second, under low light conditions, the log portion of the circuit is slow to respond causing lag. Third, a logarithmic representation of the signal in the voltage domain (or charge domain) means that small variations in signal due to fixed pattern noise leads to large variations in the represented signal.

Linear approaches are also used where the integration time is varied during a frame to generate several different signals. This approach has architectural problems if the pixel is read out at different points in time since data must be stored in some on-board memory before the signals can be fused together. Another approach is to integrate two different signals in the pixel, one with low gain and one with high gain. However, the low gain portion of the pixel often has problems processing color separation. Thus, there is a desire and need to increase the intrascene dynamic range of pixel circuits while minimizing the unwanted by-products of current designs.

### BRIEF SUMMARY OF THE INVENTION

The present invention relates to increasing intrascene dynamic range for image capturing in a pixel circuit. Embodiments of pixel circuits in accordance with the invention can be operated such that a plurality of saturation control pulses are transmitted to a transfer gate or anti-blooming gate to drain excess electrons accumulated during integration periods from a photodiode during high levels of illumination. The saturation control pulses which are of decreasing magnitude are transmitted to an integration node during respective segments of an integration time period. As a result the photo-conversion gain of the pixel circuit is progressively reduced for each integration segment. Such operation creates a pixel with a photo response having multiple “knee” points in the photo response curve, where each “knee” creates a separate region where photo-sensitivities can be independently controlled.

These and other features and advantages of the invention will be more clearly seen from the following detailed description of the invention which is provided in connection with the accompanying drawings.

### BRIEF DESCRIPTION OF THE DRAWINGS

FIG. 1 is a block diagram of an imaging device which may employ exemplary embodiments of the present invention;

FIG. 2A illustrates an exemplary four-transistor (4-T) pixel circuit schematic, wherein the transfer transistor receives a saturation control signal in accordance with a first embodiment of the invention;

FIG. 2B illustrates an exemplary cross-section of a portion of the four-transistor (4-T) pixel circuit of FIG. 2A, along with a related potential diagram and signal level transfer level;

FIG. 3 is an exemplary timing diagram of the embodiment of FIGS. 2A-B;

FIG. 4A illustrates an exemplary five-transistor (5-T) pixel circuit schematic, wherein the transfer transistor receives a saturation control signal in accordance with a second embodiment of the invention;

FIG. 4B illustrates an exemplary cross-section of a portion of the five-transistor (5-T) pixel circuit of FIG. 4A, along with a related potential diagram and signal level transfer level;

FIG. 5 is an exemplary timing diagram of the embodiment of FIGS. 4A-B;

FIG. 6A illustrates an exemplary shared floating-diffusion pixel circuit schematic, wherein the transfer transistor receives a saturation control signal in accordance with a third embodiment of the invention;

FIG. 6B illustrates an exemplary cross-section portion of a shared floating-diffusion pixel substrate of the FIG. 6A circuit;

FIG. 7 is an exemplary timing diagram of the embodiment of FIGS. 6A-B;

FIG. 8 illustrates a light-transfer function of a pixel circuit having multiple saturation control signals with varying voltage levels; and

FIG. 9 is an illustration of a processing system having an imager using saturation control signals according to the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized, and that structural, logical and electrical changes may be made without departing from the spirit and scope of the present invention.

The terms “wafer” and “substrate” are to be understood as a semiconductor-based material including silicon-on-insulator (SOI) or silicon-on-sapphire (SOS) technology, doped and undoped semiconductors, epitaxial layers of silicon supported by a base semiconductor foundation, and other semiconductor structures. Furthermore, when reference is made to a “wafer” or “substrate” in the following description, previous process steps may have been utilized to form regions or junctions in the base semiconductor structure or foundation. In addition, the semiconductor need not be silicon-based, but could be based on other semiconductors such as silicon-germanium, germanium, or gallium arsenide.

The term “pixel” refers to a picture element unit cell containing a photosensor and transistors for converting electromagnetic radiation to an electrical signal. For purposes of illustration, a representative pixel is illustrated in the figures and description herein and, typically, fabrication of all pixels in an imager will proceed simultaneously in a similar fashion.

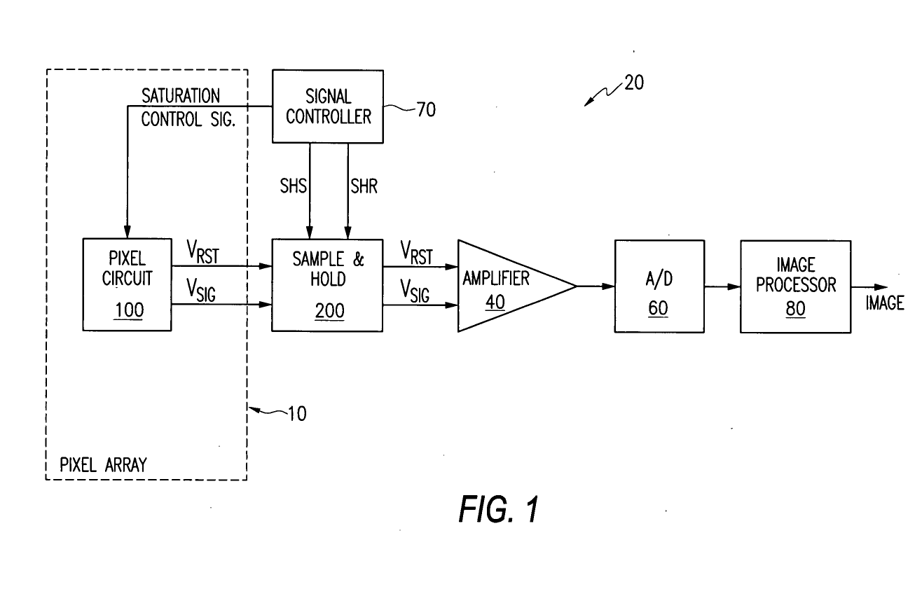

FIG. 1 shows a CMOS imaging device 20 having a pixel array 10 which can incorporate various embodiments of the present invention. The imaging device 20 includes an array 10 of pixels arranged in rows and columns (not shown) with each pixel having a pixel circuit 100. The pixel circuit 100 provides a reset signal V_{RST} and a pixel image signal V_{SIG} as outputs. These signals V_{RST}, V_{SIG} are captured by the sample and hold circuit 200 in response to sampling control signals SHR (for the reset signal) and SHS (for the image signal), respectively. A sample and hold circuit 200 is provided for each column of pixels in the array. Since the pixels are selected in a row by row fashion, each column will have a column line to which all pixels of that column are connected. The sample and hold circuit 200 provides the sampled reset signal V_{RST} and image signal V_{SIG} to an amplifier 40, which in turn provides a signal representing the difference between the reset signal and pixel image signal (V_{RST}−V_{SIG}) as an output. This difference signal is provided to an analog-to-digital (A/D) converter 60 and from there to an image processor 80 that receives digitized pixel signals from all pixel circuits 100 of the array and provides an image output. The imaging device 20 includes a saturation control signal in accordance with the various embodiments of the invention which controls an operation of the pixel circuit 100, as described in more detail below.

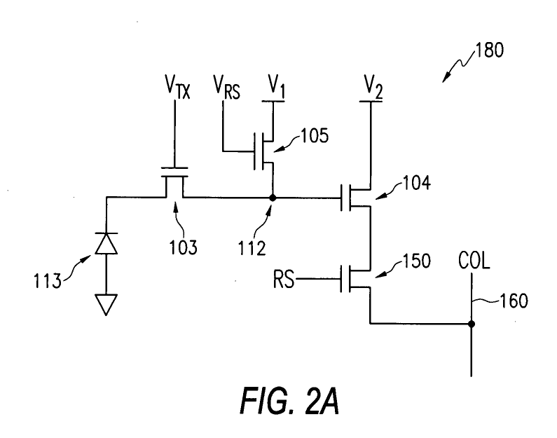

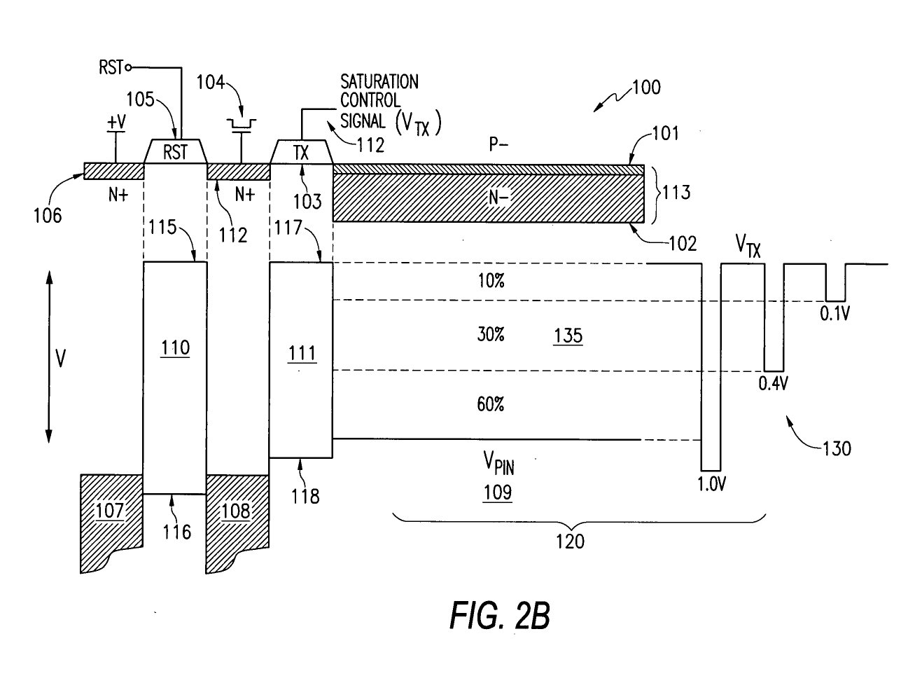

FIG. 2A illustrates an exemplary schematic diagram of a four-transistor (4-T) pixel circuit 180 in accordance with a first exemplary embodiment of the present invention. Generally, pixel circuit 180 includes a photodiode 113 that accumulates photocharge during an integration period. The photodiode 113 is coupled to a drain terminal of transfer transistor 103, which receives a saturation control signal (V_{TX}) at its gate terminal to allow charge to transfer from the photodiode 113 to a floating diffusion charge storage node 112. The source terminal of transfer transistor 103 is coupled to the floating diffusion node 112, which is further coupled to a drain terminal of a reset transistor 105. The reset transistor 105 also receives a reset voltage signal (V_{RS}) at its gate terminal. An operating voltage (V₁) is applied to the source terminals of reset transistor 105 and an operating voltage (V2) is applied to the source terminals of source-follower transistor 104. It should be understood that operating voltages V₁ and V₂ may be the same voltage, or may be different voltages from different sources. A gate terminal of source-follower transistor 104 is coupled to floating diffusion node 112 and a drain terminal of transistor 104 is coupled to a source terminal of row select transistor 150. The gate of row select transistor 150 receives a row select (RS) signal, wherein a logic high RS signal activates transistor 150 to read out the voltage on the floating diffusion node 112 to the column line 160. Further details regarding the operation of the 4-T pixel circuit 180 are given below.

FIG. 2B illustrates an exemplary cross-section 100 of a portion of the four-transistor (4-T) pixel circuit of FIG. 2A, along with a related potential diagram 120 and signal level transfer diagram 130 in accordance with a first embodiment of the invention. The cross-section 100 illustrates a buried photodiode region 113 comprising a p-type region 101 and an n-type region 102, which serves as a photodiode where photocharge is generated and accumulated until transferred. Adjacent to the buried photodiode region 113 is a transfer transistor 103, which receives a saturation control signal (V_{TX}) 112 as shown in FIG. 2B. Next to the transfer transistor 103 is a floating diffusion region 112, which is coupled to the gate of the source-follower transistor 104. Reset transistor 105 operates to reset the floating diffusion region 112 prior to the transfer of charge from the photodiode 113. Reset transistor 105 supplies a reset voltage at the diffusion region 112 when the V_{RS} signal is high.

FIG. 2B also shows a potential diagram 120 depicting potentials associated with the voltage node 106, reset transistor 105, floating diffusion node 112, the gate of transfer transistor 103 and photodiode region 113. The voltage node potential 107 is separated from the floating diffusion potential 108 by the potential barrier 110 under the gate of reset transistor 105. Potential barrier 110 is at its highest 115 when reset transistor 105 is off, and is at its lowest 116 when the transistor is on (thus, allowing electrons to drain off the floating diffusion region to the supply voltage +V). Likewise, the potential barrier 111 under the gate of transfer transistor 103 is highest 117 when transfer transistor 103 is off, and at its lowest 118 when transfer transistor 103 is on, thus allowing electrons to drain from the n-region 102 of the photodiode to floating diffusion region 112. The charge from photodiode 113 is shown in potential diagram 120 as being collected in the area 135 which has a lower boundary defined by the primary voltage V_{PIN} 109 of the photodiode 113. Charge in area 135 spills over into the potential region 108 of the floating diffusion node 112 if the barrier 111 is lowered to permit such transfer.

On the right-hand side of FIG. 2B, an exemplary variable-level saturation control signal 130 (V_{TX}) is illustrated with three different voltage pulse levels. It should be understood that the number of pulses and voltage levels may vary according to the environment of use. The first saturation control pulse (1.0V) of FIG. 2B is a full saturation control signal, wherein the pulse causes the potential barrier 111 of the transfer transistor 103 to drop to its lowest point 118, allowing substantially all (˜100%) of the electrons converted by the buried photodiode 113 to transfer to floating diffusion region 112. The second voltage signal (0.4V) of 130 is a medium saturation control signal, wherein the pulse causes the potential barrier 111 of the transfer transistor 103 to drop to a medium point, allowing approximately 40% of the electrons at the photodiode 113 to transfer to the floating diffusion region 113, thus leaving approximately 60% of the photodiode capacity to hold charge. The third voltage signal (0.1V) of 130 is a low saturation control signal, wherein the pulse causes the potential barrier 111 of the transfer transistor 103 to drop slightly, allowing approximately 10% of the photodiode electrons to transfer to the floating diffusion region 112 from photodiode 113.

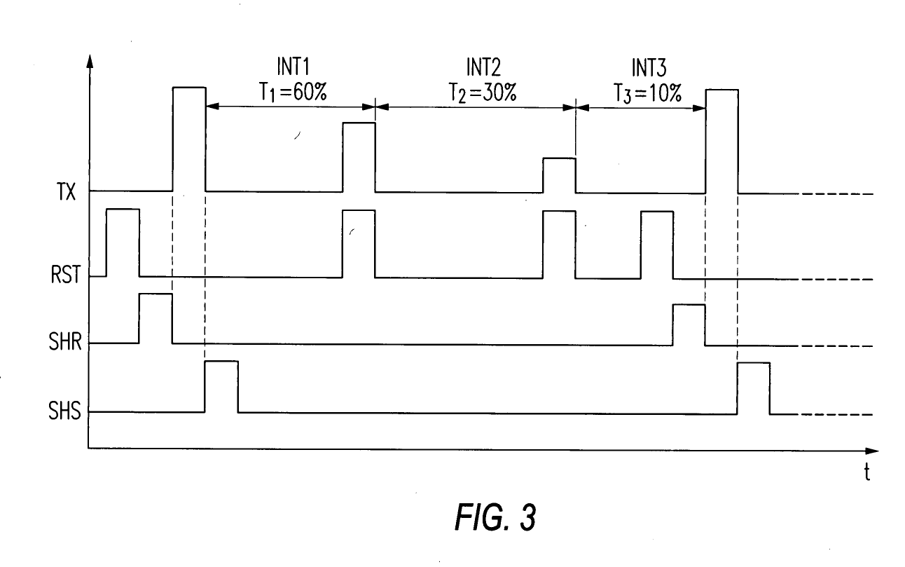

FIG. 3 illustrates an exemplary timing diagram of the FIG. 2A and 2B pixel circuit, showing the operation of the saturation control pulse (V_{TX}), reset pulse (RST), the sample-and-hold reset (or “reference”) signal (SHR) and the sample-and-hold pixel output signal (SHS) over time during a single sampling frame that includes three regions referred therein as “integration segments.” Referring back to FIG. 1, the SHR and SHS signals are applied to sample and hold circuit 200, which is coupled to column line 160 (FIG. 2A) to sample and hold the V_{RST} and V_{SIG} pixel signals produced by source follower transistor 104. The reset signal RST is pulsed just before the beginning of a next frame integration period to flush electrons from the floating diffusion region 112, thus setting the floating diffusion region to a predetermined charge state.

The sample-and-hold reset (SHR) signal is then pulsed while row select transistor 150 is on to obtain a sample reference signal V_{RST} into sample and hold circuit 200 as part of a correlated double-sampling (CDS) operation. Immediately following the SHR signal, the saturation control signal V_{TX} is pulsed at full strength to transfer substantially all the accumulated electrons from the photodiode region 113 from a just completed integration period to the floating diffusion region 112. Following the pulsing of the saturation control signal V_{TX} at full strength, the sample-and-hold signal SHS is pulsed to sample the pixel signal output V_{SIG} into sample and hold circuit 200 and a new integration period begins for photodiode 113. This new integration period is indicated in the present invention as having integration segments INT1, INT2 and INT3.

As the first integration segment (INT1) continues, the photodiode region 113 accumulates charge until the saturation control signal V_{TX} pulses again at a medium voltage level to partially clear out some of the electrons from the photodiode region 113 to the floating diffusion region 112. At the same time, the gate of the reset transistor is activated so the electrons are also transferred from the floating diffusion region 112 to the voltage source +V. Thus, under high intensity conditions where the electron storage of the photodiode may be rapidly approaching full capacity, a portion of the electrons are drained to avoid saturation. During this and all other integration periods mentioned herein, the accumulation of charge over time follows an exponential curve as a function of light intensity until the photodiode region 113 saturates. If the first integration segment (INT1) occurred under a very high illumination condition, the medium voltage pulse would clear out a portion of the excess electrons, leaving a portion of the photodiode region 113 available for additional electron accumulation. On the other hand, if the illumination is low and the photodiode region 113 has not accumulated a significant amount of electrons, the medium control signal V_{TX} pulse will not bring the transfer gate barrier 111 down to a low enough level for electrons to drain away from photodiode 113. As a result, the accumulated electrons will remain in the photodiode region 113, and further accumulation during subsequent integration period segments (INT2, INT3) in the integration period would add to the levels until the photodiode charge is again completely flushed to the floating diffusion mode 112 at the end of the integration segment INT3.

At the end of the second (medium voltage) saturation control signal (V_{TX}) pulse, a second integration segment (INT2) begins, where electrons continue to accumulate in the photodiode region 113. A third, low voltage, saturation control signal (V_{TX}) is pulsed at the end of the second integration segment (INT2) to drain excess electrons from photodiode 113. A reset pulse is also activated concurrently with the third saturation control signal (V_{TX}) to drain electrons from the floating diffusion node 112.

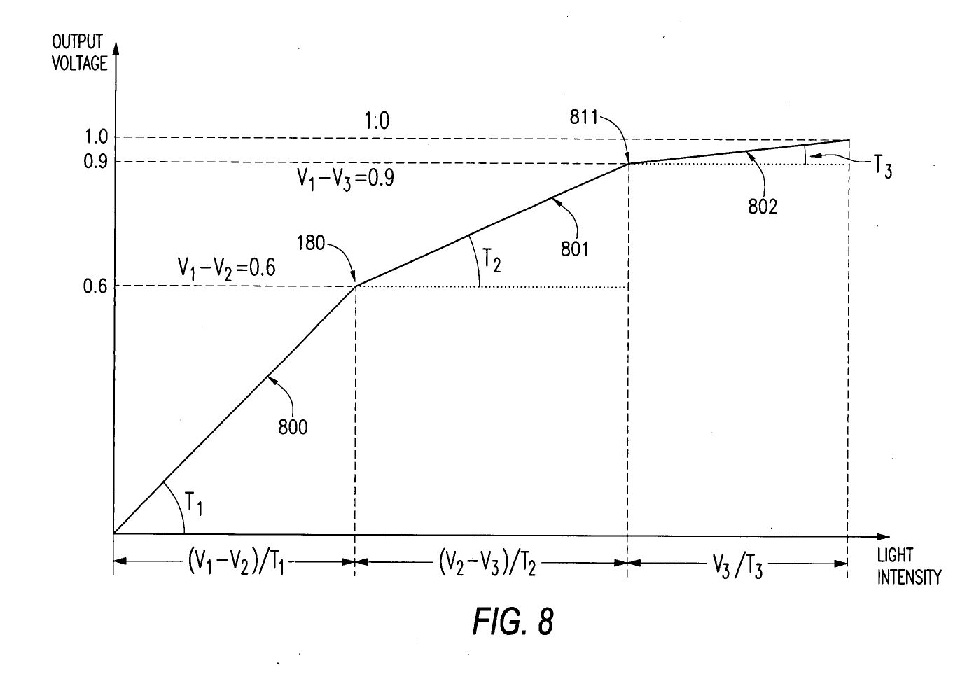

Each successive saturation pulse (V_{TX}) is smaller than the preceding one, and the intervals between pulses are timed to prevent loss of information about the intensity of light during the sampling frame. The last saturation control pulse (V_{TX}) at the beginning of a third integration segment (INT3) is therefore the smallest, helping to maintain the photo-response of the pixel by preventing saturation during the third integration segment (INT3). The saturation control pulses adjust the photo-response of the pixel circuit to provide a larger dynamic range. The photo-response is discussed in greater detail below with respect to FIG. 8.

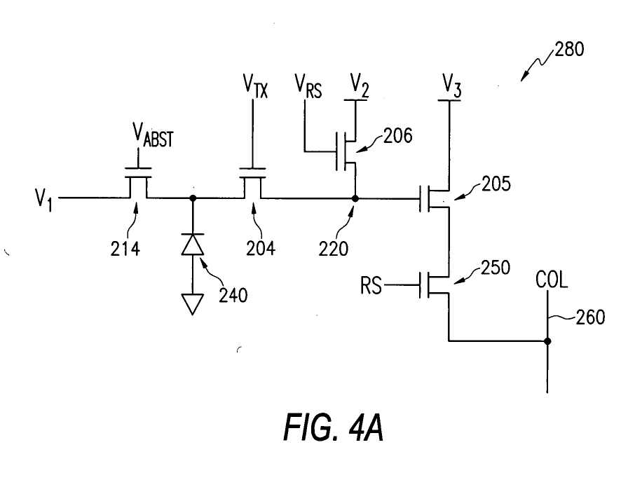

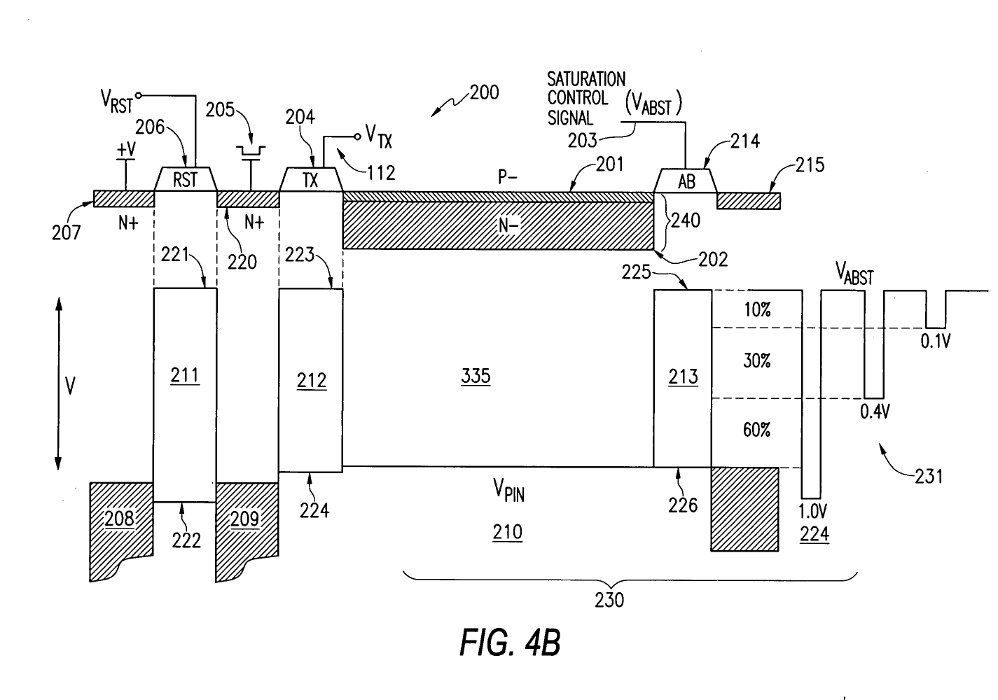

FIG. 4A illustrates an exemplary schematic of a five-transistor (5-T) pixel circuit 280 in accordance with a second embodiment of the present invention. Generally, pixel circuit 280 includes a photodiode 240 that accumulates photocharge during an integration period. The photodiode 240 is coupled to a drain terminal of anti-blooming transistor 214, whose source terminal is coupled to operating voltage (V₁). A gate terminal of anti-blooming transistor 214 receives saturation control signal (V_{ABST}), which is discussed in greater detail below. Photodiode 240 is also coupled to transfer transistor 204, which receives a transfer signal (V_{TX}) at a gate terminal to allow charge to transfer from the photodiode 240 to a floating diffusion node 220. A source terminal of transfer transistor 204 is coupled to floating diffusion node 220, which further couples to a drain terminal of reset transistor 206. Reset transistor 206 receives a reset signal (RST) at a gate terminal to activate the transistor 206 to reset the charge accumulated on the floating diffusion node 220. An operating voltage (V₂) is applied to the source terminals of reset transistor 206 while operating voltage V₃ is applied to a source-follower transistor 205. It should be understood that operating voltages V₁, V₂, and V₃ may be the same voltage, or may be different voltages from different sources. A gate terminal of source-follower transistor 205 is coupled to floating diffusion node 220. A drain terminal of source-follower transistor 205 is coupled to a source terminal of row select transistor 250. The gate of row select transistor 250 receives a row select (RS) signal, wherein a logic high RS signal activates transistor 250 to read out the charge accumulated on the floating diffusion node 220 to the column line 260 through source-follower transistor 205.

FIG. 4B illustrates an exemplary cross-section 200 of a portion of the five-transistor (5-T) pixel of FIG. 4A, along with a related potential diagram 230 and signal level transfer diagram 231. The cross-section 200 shows a biased anti-blooming region 215, adjacent to an anti-blooming transistor 214. Anti-blooming transistor 214 also has a gate coupled to saturation control signal line 203, which carries a saturation control signal (V_{ABST}). Buried photodiode 240 is adjacent to anti-blooming transistor 214. Photodiode 240 comprises a p-type region 201 and an n-type region 202, where photocharge is generated and accumulated until transferred elsewhere. Photodiode 240 can be a pinned photodiode set by a pinning photodiode voltage (V_{PIN}) 210. Adjacent to the photodiode 240 is a transfer transistor 204. Next to the transfer transistor 204 is the floating diffusion node 220, which is further coupled to the gate of source follower transistor 205. Reset transistor 206 operates to reset the floating diffusion node 220 prior to transfer of charge from photodiode 240. Reset transistor 206 is also coupled to the operating voltage node 207, which receives an external operating voltage +V, and when the RST signal is high, supplies the reset voltage to floating diffusion node 220 serving to drain off electrons and reset the node 220.

Directly below cross-section 200 is an exemplary potential diagram 230 illustrating potential levels at voltage node 207, reset transistor 206, floating diffusion node 220, transfer transistor 204, buried photodiode region 240, and the anti-blooming transistor 214 The voltage node potential 208 is separated from the floating diffusion node potential 209 by the potential barrier 211 created by reset transistor 206. Potential barrier 211 is at its highest 221 when reset transistor 206 is off, and is at its lowest 222 when the transistor 206 is on (thus allowing electrons to drain from the floating diffusion region 220). Likewise, the potential barrier 212 for transfer transistor 204 is highest 223 when transfer transistor 204 is off, and at its lowest 224 when transfer transistor 204 is on, and thus allowing electrons to drain from the buried photodiode 240 to floating diffusion node 220.

On the right-hand side of FIG. 4B, an exemplary variable-level saturation control signal 231 (V_{ABST}) is illustrated, with three different voltage levels (1.0V, 0.4V and 0.1V, all expressed as proportions of a full saturation control signal). The first pulse (1.0V) of signal 231 is a full saturation control signal, causing the potential barrier 213 of the anti-blooming transistor 214 to drop to its lowest level 226, allowing substantially all (˜100%) electrons accumulated by buried photodiode 240 to transfer from the photodiode region 240 to floating diffusion region 220. The second pulse (0.4V) of signal 231 is a medium saturation control signal, causing the potential barrier 213 of the anti-blooming transistor 214 to drop to a medium point, allowing approximately 40% of the electrons accumulated by photodiode 240 to transfer from the photodiode region 240, thus leaving approximately 60% of the photodiode capacity for holding charge. The third pulse (0.1V) of signal 231 is a low saturation control signal, causing the potential barrier 213 of the anti-blooming transistor 214 to drop slightly, allowing approximately 10% of electrons collected by photodiode 240 to transfer from the photodiode region 240.

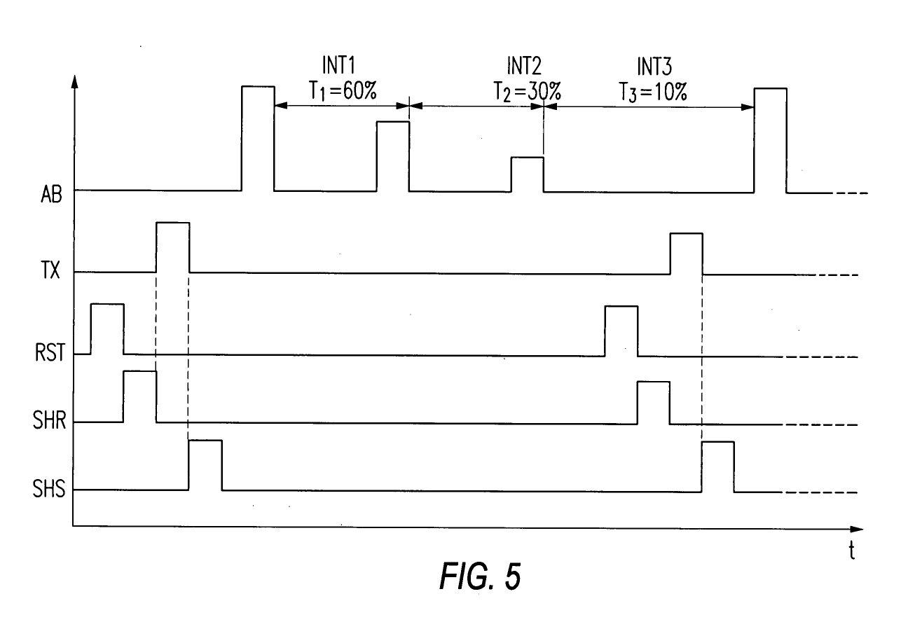

FIG. 5 illustrates an exemplary timing diagram of the FIG. 4B pixel circuit, showing the operation of the saturation control pulse (V_{ABST}), transfer pulse (TX), reset pulse (RST), the sample-and-hold reset (or “reference”) signal (SHR) and the sample-and-hold pixel output signal (SHS) over time during a sampling frame that includes three integration segments. The reset signal RST is pulsed at the end of a prior integration period just before the beginning of a new frame's first integration segment to clear electrons from the floating diffusion node 220. The sample-and-hold reset (SHR) signal is then pulsed to obtain a sample reference signal V_{RST} in sample and had circuit 200 (FIG. 1) as part of a correlated double-sampling (CDS) operation. Immediately following the SHR signal, the transfer signal TX is pulsed to clear substantially all the electrons accumulated in the photodiode 240 during a prior integration period into the floating diffusion node 220. After this, the sample-and-hold signal SHS is pulsed to sample the pixel signal output for the CDS operation.

After charge is transferred from the photodiode 240 into floating diffusion node 220, a new integration period begins. At the beginning of the new integration period, the saturation control signal V_{ABST} pulses at a high level to clear any residual charges from the photodiode 240 through anti-blooming transistor 214 to the voltage source. Charges begin to accumulate during integration segment INT1 at the end of segment INT1. A medium voltage level is applied to the gate of transistor 214 to partially transfer excess electrons from the photodiode 240 to biased anti-blooming region 215. Thus, if the first integration segment INT1 occurred under a very high illumination condition, the medium voltage V_{ABST} pulse would clear out a portion of the excess electrons, leaving a portion of the photodiode available for additional electron accumulation during subsequent integration segments. On the other hand, if the illumination is low and the photodiode region 240 has not accumulated a significant amount of electrons, the medium V_{ABST} pulse will not bring the anti-blooming barrier 213 down to a low enough level for electrons to drain away from photodiode 240. As a result, the accumulated electrons remain in the photodiode region 240.

At the end of the second (medium voltage) saturation control signal (V_{ABST}) pulse, a second integration segment (INT2) begins, where electrons continue to accumulate in the photodiode region 240. A third, low voltage (lower than the medium voltage), saturation control signal (V_{ABST}) is pulsed at the end of the second integration segment (INT2) to drain excess electrons from photodiode 240. The last saturation control pulse V_{ABST} at the beginning of a third integration segment (INT3) is preferably the smallest pulse. Charges continue to accumulate at photodiode 240 during the third integration segment INT3 until read out by the transfer transistor 204 into the floating diffusion node 220. With the pixel arrangement shown in FIGS. 4A, 4B, three different integration segments, having different photocharge accumulation characteristics are again provided.

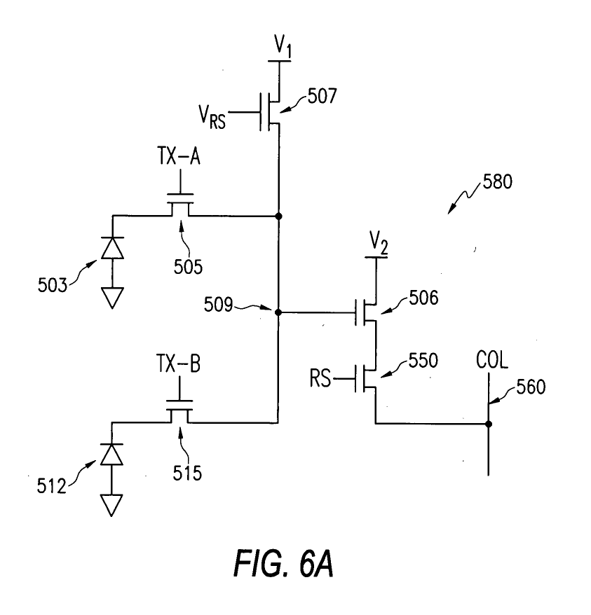

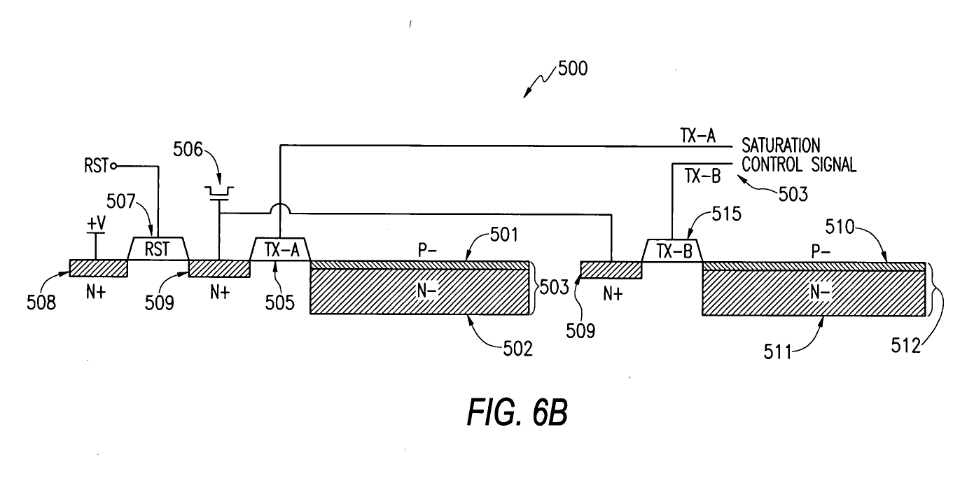

FIG. 6A is an exemplary schematic of a two-transistor (2-T) shared floating diffusion node pixel circuit 580 under a third embodiment of the invention. Generally, circuit 580 has two photodiodes 503, 512 which are respectively coupled to a the source terminals of respective transfer transistors 505, 515. Each transfer transistor (505, 515) is activated by a respective saturation control signals (TX-A, TX-B), the operation of which is described in greater detail below. Each saturation control signals TX-A, TX-B is applied to a gate terminal of a respective transistor as shown in FIG. 6A. The drain terminals of the transfer transistors 505, 515 are both coupled to a common floating diffusion node 509, which is further coupled to a gate terminal of source-follower transistor 506, and a drain terminal of reset transistor 507. The reset transistor 507 receives a reset pulse RST at the gate terminal to clear out charge from floating diffusion region 509, and has a source terminal coupled to operating voltage V₁. The source terminal of source-follower transistor 506 is coupled to an operating voltage (V₂), and the drain terminal is coupled to a source terminal of row select transistor 550. Row select transistor 550 receives a row select signal to read out the charge collected at the floating diffusion region 509, through source follower transistor 506, to column line 560. It should be understood that operating voltages V₁ and V₂ may be the same voltage, or may be different voltages from different sources.

FIG. 6B illustrates an exemplary cross-section 500 of a portion of the two-transistor (2-T) shared floating diffusion pixel circuit of FIG. 6A. The cross-section 500 illustrates first and second transfer transistors 505 and 515, respectively formed next to a first photodiode region 503 (shown as P-type region 501 and N-type region 502) and a second photodiode region 512 (shown as P-type region 510 and N-type region 511). Each transfer transistor 505, 515 is also formed next to a common floating diffusion node 509, shown for ease of explanation in FIG. 6B as having two portions. Charge from each respective photodiode is transferred to floating diffusion node 509. The charge level from common floating diffusion node 509 is read out, via transistor 506, at the end of each sampling frame. Each of the transfer transistors 505, 515 receives respective saturation control signals TX-A and TX-B of the type illustrated in FIGS. 2-5. However, the control signals TX-A and TX-B do not overlap, as described below. Reset transistor 507 operates to reset the floating diffusion region 509 and 504 prior to transfer of charge from either of photodiode regions 503 and 512. Reset transistor 507 is also coupled to the operating voltage node 508, which receives an external operating voltage +V, and when the RST signal is high, supplies the reset voltage to diffusion node 509.

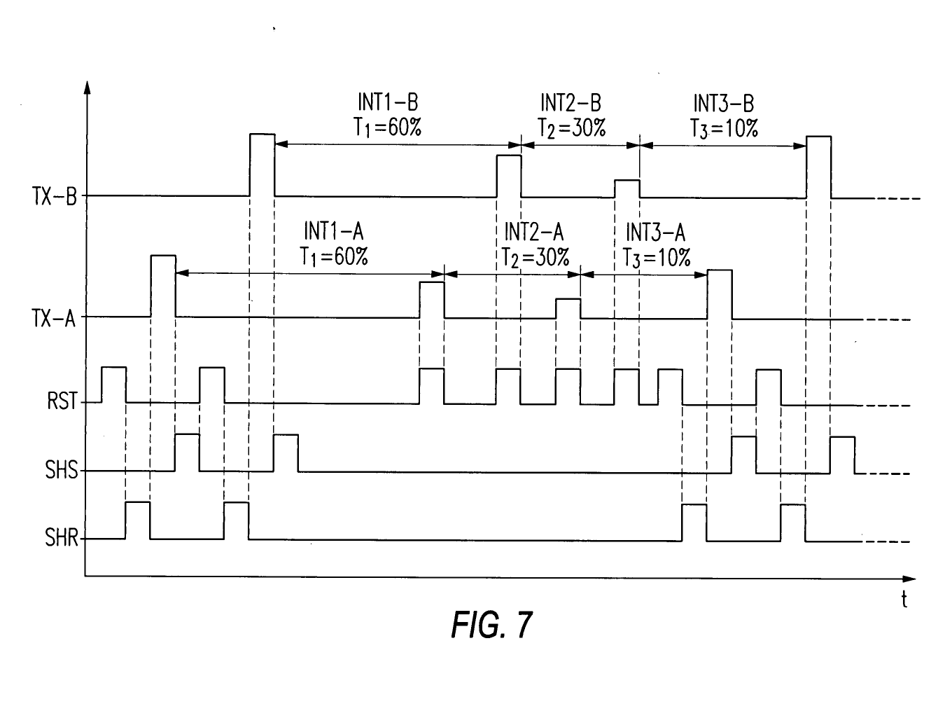

FIG. 7 illustrates an exemplary timing diagram of the FIG. 6B circuit, using variable level saturation control signals similar to those described above in connection with FIGS. 2-5. Specifically, FIG. 7 illustrates an exemplary sampling frame of the first saturation control signal (TX-A), second saturation control signal (TX-B), reset signal (RST), the sample-and-hold reset (or “reference”) signal (SHR) and the sample and hold signal (SHS) over time. The sampling frame includes three integration segments for each of the photodiodes 503, 512. The reset signal RST is pulsed just before the beginning of the first integration segment (INT1-A) of photodiode 503 to clear electrons from the floating diffusion node 509. The sample-and-hold reset (SHR) signal is then pulsed to obtain a sample reference signal for photodiode 503 for a correlated double-sampling (CDS) operation. Immediately following the SHR signal, the first saturation control signal TX-A is pulsed at full strength to begin a first integration segment (INT1-A) for the first photodiode 503. Following the pulsing of the first saturation control signal TX-A, the sample-and-hold signal SHS is pulsed to sample the pixel signal output VSIG-A from photodiode 503.

Following the SHS signal, the reset signal RST is pulsed again to clear out charge from the floating diffusion node 509, and the SHR signal is again pulsed to read out a reset signal from node 509. After this, the second saturation control signal TX-B is pulsed at full strength to transfer charge from photodiode 512 to floating diffusion node 509 and sample and hold signal SHS is again pulsed to sample the pixel signal output V_{SIG} B for photodiode 512. After transfer signal TX-A is pulsed, a new integration period for photodiode 503 begins which has integrated segments INT1-A, INT2-A, INT3-A. Likewise, after transfer signal TX-B is pulsed, a new integration period for photodiode 512 begins which has integration segments INT1-B, INT2-B and INT3-B. As each integration segment (INT1-A, INT1-B) continues, the respective photodiode regions 503, 512 accumulate charge until the first saturation control signal TX-A pulses again at a medium voltage level to partially transfer excess electrons from photodiode 503 to the floating diffusion node 509. A reset signal (RST) is simultaneously pulsed to clear the electrons from floating diffusion node 509. Saturation control signal TX-B then pulses at a medium level, to similarly transfer electrons from photodiode 512 to floating diffusion region 524, while reset signal (RST) is simultaneously pulsed to clear the electrons from floating diffusion node 509.

At the end of each second medium-voltage saturation control signal (TX-A, TX-B) pulse, a second integration segment begins (INT2-A, INT2-B) at respective photodiode regions 503, 512, where electrons continue to accumulate. A third, low voltage, saturation control signal (TX-A) is then pulsed at the end of the second integration period (INT2-A) to transfer excess electrons from photodiode 503 to floating diffusion node 509. A reset pulse RST is also activated concurrently with the third saturation control signal (TX-A) to drain transferred electrons from the floating diffusion node 509. Similarly, a third, low voltage, saturation control signal (TX-B) is pulsed at the end of the second integration period (INT2-B) to transfer excess electrons from photodiode 512 to floating diffusion node 509. A reset pulse RST is also activated concurrently with the third saturation control signal (TX-B) to drain transferred electrons from floating diffusion node 509. The last saturation control pulses are preferably the smallest.

FIG. 8 shows the photo-response of a pixel circuit under the embodiments of FIGS. 2-7, using an exemplary saturation control signal. The photo-response graph shown in FIG. 8 shows the output signal as a function of light intensity and has two “knee” points 810, 811, which respectively form at the intersection of gain responses 800 and 801, and the intersection of gain responses 801and 802. Each “knee” is dependent on the voltage level at which the saturation control signal is pulsed, as well as the integration time period. Thus, the level of gain (i.e., the slope of 800) for the first integration segment will be determined by T₁ as shown in FIG. 8, where the knee appears at the point from saturation (V₁−V₂), where V₁ is the first full-strength saturation control signal voltage, and V₂ is the second medium-level saturation control signal voltage (which ends the first integration period). The voltage output after the first integration segment will be determined by V₁−V₂/T₁.

The second photo-response gain 801 is determined by the second integration time period T₂ as shown in FIG. 8, where the knee appears at the second point from saturation (V₁−V₃), where V₁ is the first full-strength saturation control signal voltage, and V₃ is the third low-level saturation control signal voltage (which ends the second integration segment). The voltage output after the second integration segment will be determined by V₂−V₃/T₂. Finally, the third photo-response gain 802 is determined by the third integration time period T₃ as shown in FIG. 8, where the knee appears at the point of saturation (1.0). The voltage output after the third integration segment will be determined by V₃/T₃.

Although the embodiments described above use the magnitude of a control pulse (e.g., VTX, VABST, VTX-A, VTX-B) to control the amount of charge removed from a charge accumulation region of a photodiode, it is also possible to control the amount of removed charge by varying the width of the control pulse, or by controlling the amplitude and width. Also, in the embodiment of FIGS. 2A and 2B, which remove charge from the photodiode 113 to floating diffusion node 112, which charge is also transferred through reset transistor 105, it is not necessary that the transfer transistor 103 and reset transistor 105 be turned on at the same time. The reset transistor 105 can be turned on at any time at any time after charges are transferred from photodiode 113 to floating diffusion node 112 to remove charge from floating diffusion node 112

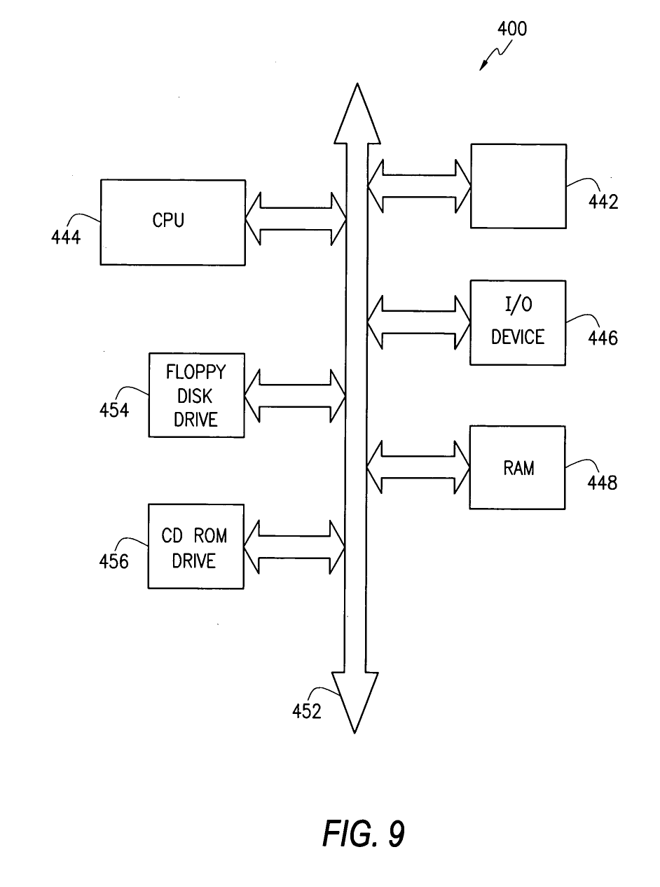

A typical processor based system which includes a CMOS imager device according to the present invention is illustrated generally at 400 in FIG. 9. A processor based system is exemplary of a system having digital circuits which could include CMOS imager devices. Without being limiting, such a system could include a computer system, camera system, scanner, machine vision system, vehicle navigation system, video telephone, surveillance system, auto focus system, star tracker system, motion detection system, image stabilization system and data compression system for high-definition television, all of which can utilize the present invention.

A processor system, such as a computer system, for example generally comprises a central processing unit (CPU) 444, for example, a microprocessor, that communicates with an input/output (I/O) device 446 over a bus 452. The CMOS imager 442 also communicates with the system over bus 452. The computer system 400 also includes random access memory (RAM) 448, and, in the case of a computer system may include peripheral devices such as a floppy disk drive 454 and a compact disk (CD) ROM drive 456 which also communicate with CPU 444 over the bus 452. CMOS imager 442 is preferably constructed as an integrated circuit which includes color pixel cells containing a photosensor, such as a photogate or photodiode formed with multiple graded doped regions, as previously described with respect to FIGS. 5-14. The CMOS imager 442 may be combined with a processor, such as a CPU, digital signal processor or microprocessor, with or without memory storage in a single integrated circuit, or may be on a different chip than the processor.

While the invention has been described in detail in connection with exemplary embodiments known at the time, it should be readily understood that the invention is not limited to the disclosed embodiments. Rather, the invention can be modified to incorporate any number of variations, alterations, substitutions or equivalent arrangements not heretofore described, but which are commensurate with the spirit and scope of the invention. Accordingly, the invention is not limited by the foregoing description or drawings, but is only limited by the scope of the appended claims.

1. A method of operating a pixel circuit, said method comprising:
accumulating photo-generated charge during an integration period;
removing some of said accumulated photo-generated charges during said integration period; and
producing an output signal based on accumulated charges existing at the end of said integration period.

2. A method as in claim 1, wherein said integration period includes a plurality of charge removal points

3. A method as in claim 2, wherein said plurality of charge removal points each has an associated signal which controls the amount of accumulated photo-generated charges which are removed.

4. A method as in claim 3, wherein each said associated signals has a different signal characteristic from another associated signal such that different amounts of charges are removed by each of said associated signals.

5. A method as in claim 4, wherein said signal characteristic is a signal pulse amplitude.

6. A method as in claim 4, wherein said signal characteristic is a signal pulse width.

7. A method as in claim 4, wherein said signal characteristic is signal pulse width and signal pulse amplitude.

8. A method as in claim 1, wherein said photo-generated charges are accumulated by a photodiode and said act of removing comprises turning on a transfer transistor to remove photo-generated charge from said photodiode to a floating diffusion node and turning on a reset transistor to remove photo-generated charge from said floating diffusion node.

9. A method as in claim 8, wherein said transfer transistor and reset transistor are turned on at the same time.

10. A method as in claim 8, wherein said reset transistor is turned on after said transfer transistor is turned on to remove charge from said photodiode to said floating diffusion node.

11. A method as in claim 1, wherein said photo-generated charges are accumulated by a photodiode and said act of removing comprises turning on a transistor coupled between said photodiode and a voltage source.

12. A method for operating a pixel circuit, said method comprising:
accumulating photo-generated charge in a photodiode during a charge integration period;
applying a first saturation control signal at a first voltage level to a transfer transistor during said integration period to remove some accumulated charge from said photodiode to a storage node;
applying a second saturation control signal to the transfer transistor during said integration period to remove additional accumulated charges from said photodiode; and
applying a reset pulse to a reset transistor coupled to said storage node each time a said first and second saturation control signal is applied.

13. The method of claim 12, wherein the second saturation control signal has a voltage that is smaller than the voltage of said first saturation control signal.

14. The method of claim 12, wherein said saturation control signals and reset signals are applied concurrently.

15. The method of claim 12, wherein said saturation control signals are respectively pulsed before the reset signals.

16. The method of claim 12, further comprising applying a third saturation control signal to said transfer transistor at the end of said integration period to transfer accumulated charges at said photodiode to a storage node.

17. The method of claim 16, wherein each of said first, second and third saturation control signals defines a segment of said integration period.

18. The method of claim 17, wherein the gain of each of the integration segments is different, and said gain of each integration portion is determined by the integration portion time period, and the voltage level of each respective saturation control signal.

19. A method for operating a pixel circuit, said method comprising the steps of:
accumulating photo-generated charge in a photodiode during a charge integration period;
applying a voltage at a transfer transistor in the pixel;
applying a first saturation control signal at a first voltage level to an anti-blooming transistor during said integration period to remove some accumulated charge from said photodiode to a storage node; and
applying a second saturation control signal to the anti-blooming transistor during said integration period to remove additional accumulated charges from said photodiode.

20. The method of claim 19, wherein the second saturation control signal has a voltage that is smaller than the voltage of said first saturation control signal.

21. The method of claim 20, further comprising applying a third saturation control signal to said transfer transistor at the end of said integration period to transfer accumulated charges at said photodiode to a storage node.

22. The method of claim 21, wherein each of said first, second and third saturation control signals defines a segment of said integration period.

23. The method of claim 22, wherein the gain of each of the integration segments is different, and said gain of each integration portion is determined by the integration portion time period, and the voltage level of each respective saturation control signal.

24. A method for operating a pixel circuit, said method comprising the steps of:
accumulating photo-generated charge in a photodiode during a first and second charge integration period;
applying a first saturation control signal at a first voltage level to a first transfer transistor during said first integration period to remove some accumulated charge from said photodiode to a storage node;
applying a second saturation control signal at a first voltage level to a second transfer transistor during said second integration period to remove some accumulated charge from said photodiode to the storage node;
applying a third saturation control signal to the first transfer transistor during said first integration period to remove additional accumulated charges from said photodiode;
applying a fourth saturation control signal to the second transfer transistor during said second integration period to remove additional accumulated charges from said photodiode; and
applying a reset pulse to a reset transistor coupled to said storage node each time said first, second, third and fourth saturation control signal is applied.

25. The method of claim 24, wherein the third saturation control signal has a voltage that is smaller than the voltage of said first saturation control signal, and the fourth saturation control signal has a voltage that is smaller than the voltage of said second saturation control signal.

26. The method of claim 25, wherein said saturation control signals and reset signals are applied concurrently.

27. The method of claim 25, wherein said saturation control signals are respectively pulsed before the reset signals

28. The method of claim 24, further comprising applying a fifth saturation control signal to said first transfer transistor at the end of said integration period to transfer accumulated charges at said photodiode to the storage node, and a sixth saturation control signal to said second transfer transistor at the end of said integration period to transfer accumulated charges at said photodiode to the storage node

29. The method of claim 28, wherein each of said first, third and fifth saturation control signals defines a segment of said first integration period, and each of said second, fourth and sixth saturation control signals defines a segment of said second integration period.

30. The method of claim 29, wherein the gain of each of the integration segments is different, and said gain of each integration portion is determined by the integration portion time period, and the voltage level of each respective saturation control signal.

31. A pixel circuit, comprising:
a photocharge collection region;
a floating diffusion region, coupled to a reset node through a reset transistor; and
a transfer transistor, coupled between the photocharge collection region and said floating diffusion region, wherein a first saturation control signal is applied at a first voltage level to said transfer transistor to start an integration period, sequentially applying additional saturation control signals to the transfer transistor, each of said additional saturation control signals having voltage levels that are successively smaller than a prior saturation control signal, and applying a reset pulse to a reset transistor each time additional saturation control signals are applied, wherein said saturation control signals and reset signals are applied simultaneously.

32. The pixel circuit of claim 31, wherein each application of an additional saturation control signal defines an integration portion in the integration period.

33. The pixel circuit of claim 33, wherein the additional saturation control signals comprise a second saturation control signal at a second voltage level that is lower than the first voltage level, said second saturation control signal defining a second integration portion in said integration period.

34. The pixel circuit of claim 33, the additional saturation control signals further comprise applying a third saturation control signal at a third voltage level that is lower than the second voltage level, said third saturation control signal defining a third integration portion in said integration period.

35. The pixel circuit of claim 34, wherein the additional saturation control signals further comprise applying a final saturation control signal at the first voltage level after the application of the third saturation control signal, said final saturation control signal ending the integration period.

36. The pixel circuit of claim 35, wherein the gain of each of the integration portions is different for the pixel circuit, said gain of each integration portion is determined by the integration portion time period, and the voltage level of each respective saturation control signal.

37. A pixel circuit, comprising:
a photocharge collection region;
a floating diffusion region, said floating diffusion region being coupled to a reset node through a reset transistor, and further being coupled to said photocharge collection region through a transfer transistor;
an anti-blooming region for receiving charge from said photodiode collection region; and
an anti-blooming transistor, said anti-blooming transistor controlling the charge transferred from the photodiode collection region to the anti-blooming region, said anti-blooming transistor receiving a first saturation control signal at a first voltage level to start a first integration period, and applying additional saturation control signals to the anti-blooming transistor, wherein each saturation control signal has a voltage level that is successively smaller with respect to a prior saturation control signal, and wherein each saturation control signal begins additional integration periods.

38. The pixel circuit of claim 37, wherein each application of an additional saturation control signal defines an integration portion in the integration period.

39. The pixel circuit of claim 38, wherein a second saturation control signal at a second voltage level is applied to the anti-blooming transistor that is lower than the first voltage level signal, said second saturation control signal defining a second integration portion in said integration period.

40. The pixel circuit of claim 39, wherein a third saturation control signal at a third voltage level is applied to the anti-blooming transistor that is lower than the second voltage level, said third saturation control signal defining a third integration portion in said integration period.

41. The pixel circuit of claim 40 wherein a final saturation control signal at a full voltage level is applied to the anti-blooming transistor after the application of the third saturation control signal, said final saturation control signal ending the integration period.

42. The pixel circuit of claim 41, wherein the gain of each of the integration portions is different, said gain of each integration portion is determined by the integration portion time period, and the voltage level of each respective saturation control signal.

43. A pixel circuit, comprising:
a first and second photocharge collection region;
a first floating diffusion region, coupled to a reset node through a reset transistor;
a second floating diffusion region, coupled to the first floating diffusion region;
a first transfer transistor, coupled between the first photocharge collection region and said first floating diffusion region; and
a second transfer transistor, coupled between the second photocharge collection region and said second floating diffusion region, wherein
a first saturation control signal at a first voltage level is applied to the first transistor to start a primary integration period, wherein a plurality of successive saturation control signals are applied to the first transfer transistor, each saturation control signal having a voltage level that is successively smaller with respect to a prior saturation control signal, each saturation control signal beginning additional integration periods;
a second saturation control signal is applied at the first voltage level to the second transistor to start a secondary integration period, a plurality of successive saturation control signals are applied to the second transfer transistor, each saturation control signal having a voltage level that is successively smaller with respect to a prior saturation control signal, each saturation control signal beginning additional integration periods, said additional saturation control signals to the second transfer transistor not overlapping any of the additional saturation control signals to the first transfer transistor; and
applying the reset signal at the reset node concurrently with each application of the saturation control signal.

44. The pixel circuit of claim 43, wherein each application of an additional saturation control signal to the first transfer transistor defines an integration portion in the primary integration period.

45. The pixel circuit of claim 44, wherein the additional saturation control signals further comprise applying a second voltage level that is lower than the first voltage level, said second voltage level defining a second integration portion in said primary integration period.

46. The pixel circuit of claim 45, wherein the additional saturation control signals comprise applying a third voltage level that is lower than the second voltage level, said third voltage level defining a third integration portion in said primary integration period.

47. The pixel circuit of claim 46, wherein the additional saturation control signals comprise applying a final saturation control signal at the first voltage level after the application of the third voltage level, said final saturation control signal ending the integration period.

48. The pixel circuit of claim 47, wherein the gain of each of the integration portions is different, said gain of each integration portion is determined by the integration portion time period, and the voltage level of each respective saturation control signal.

49. The pixel circuit of claim 48, wherein each application of an additional saturation control signal to the second transfer transistor defines an integration portion in said secondary integration period.

50. The pixel circuit of claim 43, wherein the additional saturation control signals comprise applying a second saturation control signal at a voltage level that is lower than the first saturation control signal, said second saturation control signal defining a second integration portion in said secondary integration period.

51. The pixel circuit of claim 50, wherein the additional saturation control signals comprise applying a third saturation control signal at a voltage level that is lower than the second saturation control signal, said third saturation control signal defining a third integration portion in said secondary integration period.

52. The pixel circuit of claim 51, wherein the additional saturation control signals comprise applying a final saturation control signal at the first voltage level after the application of the third saturation control signal, said final saturation control signal ending the integration period.

53. The pixel circuit of claim 52, wherein the gain of each of the integration portions is different, said gain of each integration portion is determined by the integration portion time period, and the voltage level of each respective saturation control signal.
